(19) United States
(12) Patent Application Publication
(10) Pub. No.: US 2013/0228009 A1
(43) Pub. Date: Sep. 5, 2013

(54) BRAKE PAD WEAR DETECTION SYSTEM AND METHOD

(71) Applicant: Brian T. Dix, Kennesaw, GA (US)

(72) Inventor: Brian T. Dix, Kennesaw, GA (US)

(21) Appl. No.: 13/411,617

(22) Filed: Mar. 4, 2012

(51) Int. Cl. G01L 5/28

(52) U.S. Cl. 73/121

(57) ABSTRACT

Systems and methods to determine brake pad wear are provided. A linear enclosure may include an opening and a cap proximate the opening. The cap includes a cap surface. A slide bolt may be configured to move in a first direction within the linear enclosure. A shaft may be in axial alignment with the slide bolt. A biasing mechanism may bias the shaft in the first direction towards the slide bolt. Sensor circuitry may generate a first signal indicative of brake pad wear in response to movement of the shaft.

### FIELD OF THE INVENTION

The present invention relates generally to vehicular braking systems, and more specifically, to sensor systems used to monitor brake pad and other braking components.

### BACKGROUND

Automobiles, motorcycles, heavy machinery and other vehicles use friction braking to convert kinetic energy into heat. Typically, a brake pad made of a friction absorbing material is pressed against a metal rotor, or disc, attached to a rotating axle or wheel. The brake pad absorbs energy, and the vehicle experiences negative acceleration. A floating caliper moves with respect to the disc (i.e., along a line parallel to the axis of rotation of the disc). A piston on one side of the disc pushes an inner brake pad until it makes contact with the braking surface. The piston pulls a caliper body with an outer brake pad so pressure is applied to both sides of the disc.

The brake pads are sacrificial in that they protect the more expensive rotor. The brake pads are intended to be slowly ablated during repeated braking applications. Wear-through of the brake pads can create an emergent brake failure. The resultant metal-to-metal contact can erode expensive parts.

Brake pad sensors are used to inform vehicle operators of an impending wear-through. However, conventional brake pad sensor may induce noise and require replacement whenever the brakes are replaced. Such brake pad sensing systems may further require additional parts, can be time-consuming to install, and can be incompatible with original equipment manufacturer (OEM) components.

### SUMMARY OF THE DISCLOSURE

In a particular embodiment, an apparatus includes a linear enclosure having an opening and a cap proximate the opening. The cap includes a cap surface. A slide bolt may be configured to move in a first direction within the linear enclosure. A shaft may be in axial alignment with the slide bolt. A biasing mechanism may bias the shaft in the first direction towards the slide bolt. Sensor circuitry may generate a first signal indicative of brake pad wear in response to movement of the shaft.

According to another particular embodiment, an apparatus includes a cap having a cap surface. The cap surface may be positioned proximate an opening of an enclosure partially enclosing a slide bolt that is configured to move in a first direction. A shaft may be in axial alignment with the slide bolt and may be biased in the first direction. The shaft may include a first portion that extends in the first direction relative to the cap surface and a second portion that extends in a second, opposite direction relative to the cap surface. Sensor circuitry may generate a first signal indicative of brake pad wear in response to movement of the shaft.

According to another particular embodiment, a method of determining brake pad wear includes positioning a cap having a cap surface proximate an opening of an enclosure. The enclosure at least partially encloses a slide bolt configured to move in a first direction. The method further may include positioning a shaft in axial alignment with the slide bolt. The shaft includes a first portion that extends in the first direction away from the cap surface and a second portion that extends in a second direction away from the cap surface and opposite the first direction. The shaft may be biased in the first direction. A first signal indicative of brake pad wear may be generated at a sensor in response to movement of the shaft.

An embodiment of a brake sensor does not touch the rotor and generate noise. The brake sensor may be installed in minutes without replacing the brakes. An embodiment of a brake sensor retrofits an existing brake sensor and plugs-in without additional parts. The distance between the caliper bolt and the sensor plunger increases as the brake pads wear. As a result, an embodiment of a brake sensor will not interfere with brake operation even should the brake system fails and seizes. The brake system may be reusable and may not have to be changed at every brake job.

These and other advantages and features that characterize the invention are set forth in the claims annexed hereto and forming a further part hereof. However, for a better understanding of the invention, and of the advantages and objectives attained through its use, reference should be made to the Drawings and to the accompanying descriptive matter in which there are described exemplary embodiments of the invention.

### BRIEF DESCRIPTION OF THE DRAWINGS

FIG. 1 is a diagram of an embodiment of a brake pad sensor system installed in a vehicle having new brake pads;

FIG. 2 is a diagram of an embodiment of a brake pad sensor system installed in a vehicle having brake pads exhibiting an intermediate degree of wear;

FIG. 3 is a diagram of an embodiment of a brake pad sensor system installed in a vehicle having brake pads exhibiting an advanced degree of wear; and

FIG. 4 is a diagram of an embodiment of a brake pad sensor system having a cap that substantially encloses a sensor shaft and associated switches.

### DETAILED DESCRIPTION

An embodiment of a brake pad wear detection system combines an electrical measurement (e.g., a resistance or a voltage measurement) with another input to determine when a brake pad should be replaced. For instance, a dynamic stability control computer may receive inputs relating to at least one of vehicle speed, brake pressure, and individual wheel speed. Other inputs may include the mileage at the time new brakes are installed. An input may include how many miles are traveled before the resistance changes from zero ohms to one or multiple threshold voltages (e.g., 470 ohms). Another input may regard how many miles are traveled between the point where the threshold resistance and an open status (infinite ohms). Times and distances corresponding to the signal changes may be used along with the other inputs to count down the mileage until a next replacement.

Changing resistance values may correspond to a changing voltage drop across a known value, fixed resistor known to the dynamic stability control computer. In this manner, an embodiment of the brake pad wear detection system uses the resistance values to modify a voltage signal or drop that is read by the dynamic stability control computer.

An embodiment of the brake sensing system may include a potentiometer, Hall-effect senor, or variable resistor (e.g., instead of a fixed resistance step) to send a live measurement of the brake pad thickness. This embodiment may require fewer calculations and with reprogramming.

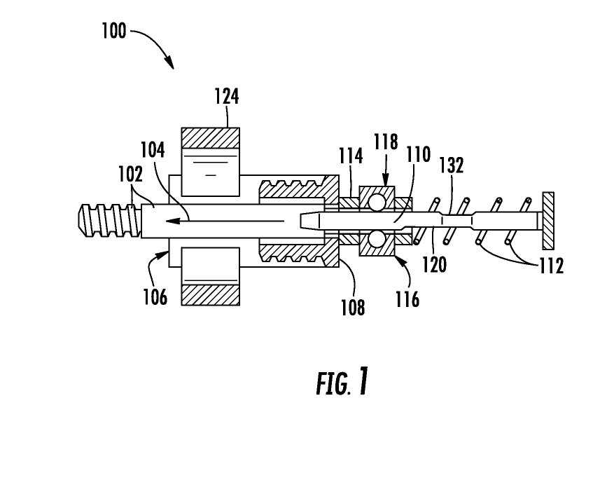

FIG. 1 shows an embodiment of a brake sensor system 100 that includes a brake caliper slide bolt 102, or pin, configured to move in a first direction (indicated by arrow 104) in response to brake pad wear. More particularly, as the brake pad wears, the caliper slide bolt 102 slides within a linear enclosure, or rubber slide bolt boot 106, towards the brake pad (not shown). A cap 108 proximate an opening may partially seal the brake caliper slide bolt 102 and the rubber slide bolt boot 106.

An end of a shaft 110, or plunger, in axial alignment with the slide bolt may contact an end of the slide bolt 102. In a particular embodiment, the shaft 110 includes a first portion that extends in the first direction relative to a surface of the cap 108 and a second portion that extends in a second, opposite direction relative to the surface of the cap 108.

A biasing mechanism 112 may bias the shaft 110 in the first direction 104. For example a spring may bias the shaft 110 towards the slide bolt 102 in such a manner that the shaft 110 remains in substantially contact with the slide bolt 102 as the slide bolt 102 moves.

A sensor module 114 may include a channel to accommodate movement of the shaft 110. For example, the sensor module 114 may comprise a hollow plastic cylindrical structure. The sensor module 114 may further include sensor circuitry configured to generate a first signal indicative of brake pad wear in response to movement of the shaft 110. In FIG. 1, the sensor circuitry may include a first switch 116 and a second switch 118. In a particular embodiment, the sensor module 114 may be attached or integral with one or more of the cap 108 and the biasing mechanism 112.

The shaft 110 may include a first indicator 120 that is sensed by the sensor circuitry, which initiates generation of the first signal at the sensor circuitry. The first indicator 120 may comprise at least one of a depression and a projection that may contact-switch or otherwise activate the first switch 116. The first and second switches 116, 118 of an embodiment are contact switches that are substantially aligned with one another. In another embodiment, additional switches are included and may be staggered relative to one another. Both switches 116, 118 may be depressed when not in contact with the indicators 120, 122. More particularly, the switches 116, 118 may be depressed when contacting a surface of the shaft 110 that does not include a depression, as shown in FIG. 1.

As shown in later figures, the first switch 116 may raise when the first indicator 120 (e.g., depression) of the shaft 110 passes by the first switch 116 as the shaft 110 traverses towards the receding slide bolt 102. At the same time, the second switch 118 may remain pushed down because the opposing surface of the shaft 110 is not receded at the second switch 118. Both switches may be raised when a second indicator 122 (e.g., depression) of the shaft 110 is positioned proximate the second switch 118. At the same time, the first switch 116 may remain in its raised position because it is proximate the first indicator 120. As discussed herein, generation of a second signal at the sensor circuitry may be initiated when the second indicator trips the second switch 118.

In the embodiment of FIG. 1, the cap 108 includes an aperture through which the shaft 110 is configured to travel. The cap 108 may be formed of rubber, plastic, or metal and may seal the slide bolt boot 106 and the slide bolt 102 from contaminant. The cap 108 may be attached or integral with the sensor module 114.

As shown in FIG. 1, the slide bolt 102 may be flush with the end of the slide bolt boot 106 when an automobile has new brake pads and a caliper body 124 is moved fully outward from the centerline of the automobile. The shaft 110 may be seated in a bottom portion of the slide bolt 102. For example, the shaft 110 may seat inside a hex shape cutout at an end of the slide bolt 102. A spring comprising the biasing mechanism 112 may be stretched, or extended, because the shaft 110 is pushed out by the slide bolt 102.

In operation, the shaft 110 may slide in the first direction, biased by the biasing mechanism 112. The shaft 110 may be in constant contact on the end of the slide bolt 102 as the outer brake pad wears and the caliper body 124 moves inboard toward the centerline of the vehicle. The indicators 120, 122 on the shaft 110 may cause the two switches 116, 118 to open in sequence. The first switch 116 may short past a 250 ohm resistor, giving a resistance of zero ohms when the brakes are new. About one third of the way through the life of the brake pad, the first switch 116 may reach the first indicator 120 and may spring open. The reading across the second switch 118 will reach the second indicator 122 and open, cutting off any continuity across the sensor module 114. This sequenced operation may match the factory sensor's zero ohms to 250 ohms to open signal exactly, but without having the sensor touching the rotor and causing noise.

Where the brake pads are completely worn out, the caliper body may have moved fully inboard on its slide pins. The spring of the sensor may be fully collapsed. The plunger may be in a position where both switches are open and infinite resistance is indicated.

In another embodiment, the sensor circuitry includes a potentiometer. In another or the same embodiment, sensors may be positioned on the shaft, in addition or in the alternative to being positioned within the sensor module. One skilled in the art will appreciate the illustrated depressions could alternatively be projections comprising raised portions of the shaft configured to active switches to facilitate brake wear detection.

Inputs (e.g., a resistance or a voltage measurement) from the sensor circuitry may be combined with another input to determine when a brake pad should be replaced. For instance, a dynamic stability control computer may receive inputs relating to at least one of vehicle speed, brake pressure, and individual wheel speed. Other inputs may include the mileage at the time new brakes are installed. An input may include how many miles are traveled before the resistance changes from zero ohms to one or multiple threshold voltages. Another input may regard how many miles are traveled between the point where the threshold resistance and an open status. Times and distances corresponding to the signal changes may be used along with the other inputs to count down the mileage until a next replacement.

The brake sensor of FIG. 1 does not touch the rotor and generate noise. The brake sensor may be installed in minutes without replacing brake pads, calipers or other components. An embodiment of a brake sensor retrofits an existing brake sensor and plugs-in without additional parts. The brake sensor will not interfere with brake operation even if the brake system fails and seizes is reusable.

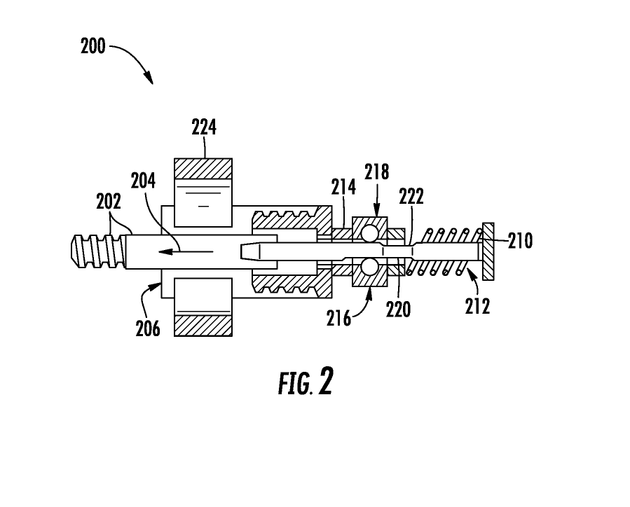

FIG. 2 shows an embodiment of a brake pad sensor system 200 installed in a vehicle having brake pads exhibiting an intermediate degree of wear. The brake pad sensor system 200 could be the brake pad sensor system 100 of FIG. 1, but with the slide bolt 102 and the shaft 110 having moved inboard.

As the slide bolt 202 and the shaft 210 move in the direction 204, the biasing mechanism 212 may recoil, accordingly. The biasing mechanism may cause the shaft 210 to be in constant contact with the end of the slide bolt 202 as the outer brake pad wears and the caliper body 224 moves inboard toward the centerline of the vehicle. As a result of the progression of the shaft 210 within the sensor module 214, a first depression 220 in the shaft 210 may be positioned proximate a switch 216. The switch 216 may consequently spring open. Another switch 218 may remain closed by the substantially opposite surface of the shaft 210.

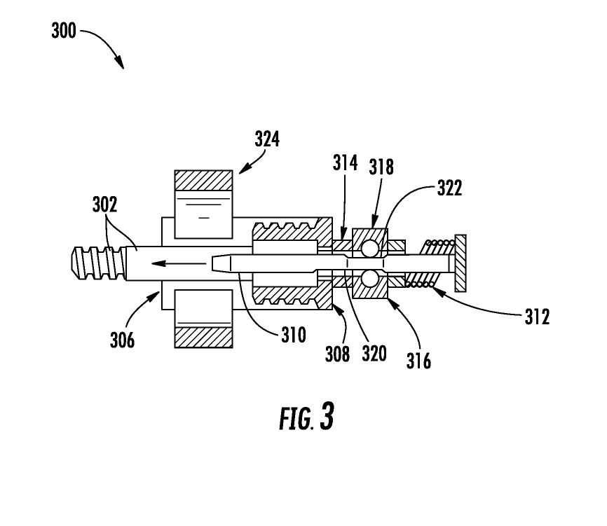

FIG. 3 shows a brake sensor brake pad sensor system 300 installed in a vehicle having brake pads exhibiting a significant or a total degree of wear. The brake pad sensor system 300 could be the brake pad sensor system 200 of FIG. 2, but with the slide bolt 202 and the shaft 210 having moved further inboard.

As the shaft 310 moves within the sensor module 214, a first depression 320 in the shaft 310 may continue to be positioned proximate a first switch 316. The switch 316 may consequently remain sprung open. A second depression 322 of the shaft 310 may pass near a second switch 318. The second switch 318 may spring open into the vacancy of the depression. Activation of one or more of the first and second switches 316, 318 may initiate generation of an electrical signal having a voltage, current, or resistive value. The electrical signal may be combined with additional inputs to indicate that a brake pad has become worn down.

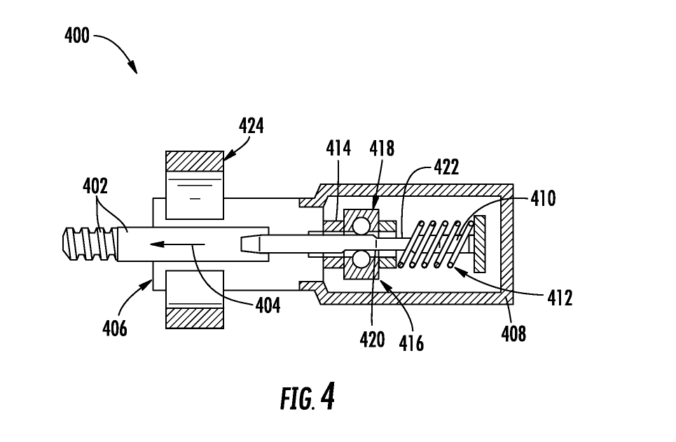

FIG. 4 shows a brake sensor with a cap 408 substantially encapsulating a brake sensor module 414. The cap 408 may further enclose a biasing mechanism 412 and a least a portion of a shaft 410. The cap 408 may remain stationary, while the cap of another embodiment may move (e.g., by force provided by a biasing mechanism).

In operation, a particular method of determining brake pad wear using the brake pad sensor of any of FIGS. 1-4 may include positioning a cap proximate an opening of an enclosure that partially encloses a slide bolt. For example, the cap 108 of FIG. 1 may be positioned proximate an opening the slide bolt boot 106. The cap may include a cap surface, and the slide bolt may be configured to move in a first direction. For instance, the cap may include a vertical sealing surface that is perpendicular to an axis of the slide bolt boot 106. The slide bolt 302 may travel in a first direction 104 as a result of brake bad wear.

A shaft may be positioned in axial alignment with the slide bolt. For example, the shaft 110 may be positioned in axial alignment with the slide bolt 102 of FIG. 1. The shaft may include a first portion that extends in the first direction away from the cap surface and a second portion that extends in a second direction away from the cap surface. For instance, a portion of the shaft 110 of FIG. 1 may be located left of the vertical surface of the cap 108, and another portion of the shaft 110 may be located to the right of the cap surface. The second direction may be opposite the first direction. The shaft may be biased in the first direction. For example, the biasing mechanism 112 of FIG. 1 may bias the shaft 110 in the direction 104. A first signal indicative of brake pad wear may be generated at a sensor in response to movement of the shaft. For instance, the one or more of the switches 116, 118 of the sensor module 114 of FIG. 1 may generate a signal that may be combined with other inputs to determine brake pad wear.

While the present invention has been illustrated by a description of various embodiments and while these embodiments have been described in considerable detail, it is not the intention of the Applicant to restrict, or any way limit the scope of the appended claims to such detail. The invention in its broader aspects is therefore not limited to the specific details, representative apparatus, method, and illustrative examples shown and described. Accordingly, departures may be made from such details without departing from the spirit or scope of Applicant's general inventive concept.

1. An apparatus, comprising:
a linear enclosure having an opening;
a cap proximate the opening and having a cap surface;
a slide bolt configured to move in a first direction within the linear enclosure;
a shaft in axial alignment with the slide bolt;
a biasing mechanism biasing the shaft in the first direction towards the slide bolt; and
sensor circuitry to generate a first signal indicative of brake pad wear in response to movement of the shaft.

2. The apparatus of claim 1, wherein the shaft includes a first indicator that is sensed by the sensor circuitry and initiates generation of the first signal at the sensor circuitry.

3. The apparatus of claim 2, wherein the first indicator includes at least one of a depression and a projection.

4. The apparatus of claim 2, wherein the shaft includes a second indicator used to initiate generation of a second signal at the sensor circuitry.

5. The apparatus of claim 4, wherein the second indicator includes at least one of a depression and a projection.

6. The apparatus of claim 1, wherein the sensor circuitry includes at least one of a potentiometer and a hall-effect sensor.

7. The apparatus of claim 1, wherein the cap includes a second aperture through which the shaft is configured to travel.

8. The apparatus of claim 1, wherein the biasing mechanism includes a spring.

9. The apparatus of claim 1, wherein the shaft directly contacts the slide bolt.

10. The apparatus of claim 1, wherein the cap is attached to the sensor circuitry.

11. The apparatus of claim 1, further comprising a processor configured to determine a service status associated with a brake pad by using the first signal in addition to an input that relates to at least one of a vehicle speed, a brake pressure, a wheel speed, a mileage at a time when brake pads are serviced, and a mileage traveled in relation to generation of the first signal.

12. An apparatus, comprising:
a cap having a cap surface, wherein the cap surface is positioned proximate an opening of an enclosure partially enclosing a slide bolt configured to move in a first direction;
a shaft in axial alignment with the slide bolt and biased in the first direction, wherein the shaft includes a first portion that extends in the first direction relative to the cap surface and a second portion that extends in a second, opposite direction relative to the cap surface; and
sensor circuitry to generate a first signal indicative of brake pad wear in response to movement of the shaft.

13. The apparatus of claim 12, wherein the sensor circuitry includes at least one switch.

14. The apparatus of claim 12, wherein the shaft includes a first portion that extends in the first direction relative to the cap surface and a second portion that extends in a second portion relative to the cap surface.

15. The apparatus of claim 12, wherein the apparatus does not directly contact a rotor.

16. The apparatus of claim 12, wherein the apparatus is reusable.

17. The apparatus of claim 12, wherein the apparatus is installed without replacing a brake pad.

18. A method of determining brake pad wear, the method comprising:
positioning a cap having a cap surface proximate an opening of an enclosure, wherein the enclosure at least partially encloses a slide bolt configured to move in a first direction;
positioning a shaft in axial alignment with the slide bolt, wherein the shaft includes a first portion that extends in the first direction away from the cap surface and a second portion that extends in a second direction away from the cap surface and opposite the first direction;
biasing the shaft in the first direction; and
generating a first signal indicative of brake pad wear at a sensor in response to movement of the shaft.

19. The method of claim 18, further comprising determining a service status associated with a brake pad by using the first signal in addition to an input that relates to at least one of: a vehicle speed, a brake pressure, a wheel speed, a mileage at a time when brake pads are serviced, and a mileage traveled in relation to generation of at least the first signal.

20. The method of claim 18, further comprising using a first indicator proximate the shaft to initiate generation of the first signal and a second indicator proximate the shaft to initiate generation of a second signal at the sensor circuitry.
